(19) United States
(12) Patent Application Publication
(10) Pub. No.: US 2026/0271968 A1
(43) Pub. Date: Sep. 17, 2026

(54) LOW FAT HYPOALLERGENIC FOOD COMPOSITION FOR COMPANION ANIMALS

(71) Applicant: MARS, INCORPORATED, McLean, VA (US)

(72) Inventors: Helene CHARLES, Aimargues (FR); Benedicte GARZINO, Aimargues (FR); Vincent FRADIN, Aimargues (FR)

(73) Assignee: MARS, INCORPORATED, McLean, VA (US)

(21) Appl. No.: 19/472,591

(22) PCT Filed: Apr. 3, 2024
(86) PCT No.: PCT/US2024/022724

§ 371 Date: Oct. 3, 2025

(30) Foreign Application Priority Data
Apr. 6, 2023 (EP) 23167128.0

(51) Int. Cl. A23K 20/147; A23K 10/26; A23K 10/30; A23K 50/42

(52) U.S. Cl. CPC A23K 20/147; A23K 10/26; A23K 10/30; A23K 50/42

(57) ABSTRACT

The present disclosure provides a low fat hypoallergenic nutritionally complete food composition for a companion animal including from about 50 to about 80 g/Mcal of proteins, said proteins comprising at least about 80% of hydrolysed proteins, from about 120 to about 180 g/Mcal of starch, said starch being from at least one rice source, from about 10 to about 30 g/Mcal of Total Dietary Fibers (TDF), and less than about 25 g/Mcal of fat. The composition can be used for companion animals affected with adverse food reactions (AFR), such as concomitant hyperlipidaemia, lymphangiectasia or any form of fat intolerance, fat malabsorption, and/or nutritional support of chronic enteropathies.

### 1. CROSS-REFERENCE TO RELATED APPLICATIONS

This application claims the benefit of priority to European Patent Application No. 23167128.0 filed on Apr. 6, 2023, the contents of which are incorporated herein by reference in their entirety.

### 2. FIELD OF THE DISCLOSURE

The present disclosure relates to a low fat hypoallergenic nutritionally food composition for achieving fat restriction in companion animals affected with adverse food reactions (AFR), such as in case of concomitant hyperlipidemia, lymphangiectasia or any form of fat intolerance, fat malabsorption, and/or nutritional support of chronic enteropathies, in particular in case of protein losing enteropathy.

### 3. BACKGROUND OF THE DISCLOSURE

Protein-losing enteropathy (PLE) is a syndrome of excessive intestinal protein loss secondary to disease affecting the enteric mucosa and surrounding structures. While the exact mechanisms resulting in the protein loss have not been well described in veterinary medicine, it is likely the result of altered intestinal permeability, direct mucosal erosion or ulceration association with altered lymphatic function and direct loss of protein-rich lymph.

While potential causes of PLE are numerous, idiopathic inflammatory bowel disease and intestinal lymphangiectasia (IL) are considered the most common causes of PLE in the dog.

In humans with PLE, nutritional management is considered the mainstay of therapy. Similar importance is placed on dietary therapy in dogs with PLE. While a novel or hydrolysed protein diet is often suggested for dogs with inflammatory enteropathies, strict fat restriction is often recommended for dogs with IL. Therefore, difficulty may arise with the dietary choice when managing a patient with histopathologic evidence of both inflammatory enteropathy and lymphangiectasia, as the commercially available hydrolysed diets generally have greater fat content than what is typically recommended for dogs with lymphangiectasia.

U.S. Patent Publication No. 2017/0332669 discloses an extruded packaged pet food product for a low-fat diet. Notably, the disclosure does not teach a hypoallergenic diet using hydrolysed proteins. European Patent Application No. 3 639 674 discloses hypoallergenic pet foods with a limited, at most 30% by weight, amount of starch, where lower amounts of starch are associated with lower energy density.

Therefore, there remains a need for nutritionally complete food compositions that are adapted for the diet of companion animals who combine one or more dietary restrictions including those of a low fat diet and a hypoallergenic diet.

In particular, there remains a need for nutritionally complete food compositions that are low in fat but may also be recommended to companion animals who require a hydrolysed protein diet, such as animals suffering from adverse food reaction.

There further remains a need for nutritionally complete food compositions that are hypoallergenic and low in fat and may be recommended to companion animals suffering from hyperlipidemia.

There further remains a need for nutritionally complete food compositions that are hypoallergenic and low in fat and may be recommended to companion animals suffering from fat intolerance or fat malassimilation.

In particular, such complete nutritionally complete food compositions should remain palatable, well tolerated by the pet and easily produced, despite their low-fat content.

### 4. SUMMARY OF THE DISCLOSURE

According to a first aspect, the present disclosure relates to a low fat hypoallergenic nutritionally complete food composition for a companion animal including from about 50 g/Mcal to about 80 g/Mcal of proteins, said proteins including at least about 80% of hydrolysed proteins, from about 120 g/Mcal to about 180 g/Mcal of starch, said starch being from at least one rice source, from about 10 g/Mcal to about 30 g/Mcal of Total Dietary Fibers (TDF), and less than about 25 g/Mcal of fat.

According to another aspect, the disclosure relates to method of manufacturing a low fat hypoallergenic nutritionally complete food composition for a companion animal including at least a step of mixing all the ingredients together.

According to another aspect, it relates to a low fat hypoallergenic nutritionally complete food composition according to the disclosure or obtained with the method according to the disclosure for use in nutritional support of a companion animal suffering from adverse food reaction.

It further relates to a low fat hypoallergenic nutritionally complete food composition according to the disclosure or obtained with the method according to the disclosure for use in nutritional support of a companion animal suffering from fat intolerance and/or fat malassimilation.

Another aspect relates to a low fat hypoallergenic nutritionally complete food composition according to the disclosure or obtained with the method according to the disclosure for use in nutritional support of a companion animal suffering from hyperlipidemia.

### 5. DETAILED DESCRIPTION OF THE DISCLOSURE

One of the objectives of the disclosure is to provide a well-tolerated new diet food composition that can be fed to companion animals requiring more than one dietary restriction including a low-fat diet and a hypoallergenic diet.

For clarity and not by way of limitation, this detailed description is divided into the following sub-portions:
5.1 Definitions
5.2 Units
5.3 Low Fat Hypoallergenic Food Compositions
5.4 Uses and Methods of Making Low Fat Hypoallergenic Food Compositions

### 5.1. Definitions

The terms used in this specification generally have their ordinary meanings in the art, within the context of this subject matter and in the specific context where each term is used. Certain terms are defined below to provide additional guidance in describing the compositions and methods of the disclosed subject matter and how to make and use them.

As used in the specification and the appended claims, the singular forms “a”, “an”, and “the” include plural referents unless the context clearly dictates otherwise. Thus, for example, reference to “a compound” includes mixtures of compounds.

The term “about” or “approximately”, as used herein, means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 10%, more preferably up to 5%, and more preferably still up to 1% of a given value.

As used herein, the terms “includes”, “including”, “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

In the detailed description herein, references to “embodiment,” “an embodiment,” “one embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, a “companion animal” or “pet” refers to domestic or wild animals. In certain embodiments, it can refer to canines, including dogs, or felines, including cats.

As used herein, the term “feline” encompasses animals, including pet animals selected from cheetah, puma, jaguar, leopard, lion, lynx, liger, tiger, panther, bobcat, ocelot, smilodon, caracal, serval and cats. As used herein, cats encompass wild cats and domestic cats. In particular embodiments, the cats are domestic cats.

As used herein, the term “canine” encompasses animals, including pet animals selected from recognized dog breeds (some of which are further subdivided), which may can include afghan hound, airedale, akita, Alaskan malamute, basset hound, beagle, Belgian shepherd, bloodhound, border collie, border terrier, borzoi, boxer, bulldog, bull terrier, cairn terrier, chihuahua, chow, cocker spaniel, collie, corgi, dachshund, dalmatian, doberman, English setter, fox terrier, German shepherd, golden retriever, great dane, greyhound, griffon bruxellois, Irish setter, Irish wolfhound, King Charles spaniel, Labrador retriever, lhasa apso, mastiff, newfoundland, old English sheepdog, papillion, pekingese, pointer, pomeranian, poodle, pug, rottweiler, St. Bernard, saluki, samoyed, schnauzer, Scottish terrier, Shetland sheepdog, shih tzu, Siberian husky, Skye terrier, springer spaniel, West Highland terrier, whippet, Yorkshire terrier, etc.

As used herein, the term “food composition” or “diet” covers all of foodstuff, diet, food, or a material that can contain proteins, carbohydrates, and/or crude fats. Foods can also contain supplementary substances or additives, for example, minerals, vitamins and condiments. Such food compositions can be nutritionally complete. In a particular embodiment, a food composition according to the present disclosure is a nutritionally complete food composition.

As used herein, the term “wet food” or “wet food composition” generally refers to a food composition that can have a moisture content of about 30% or more, generally more than about 40% by weight, relative to the total weight of the food composition. In certain embodiments, the wet food composition can have a moisture content lower than about 90% by weight, relative to the total weight of the food composition. In general, it is the final product of a process which includes a final step of sterilization instead of final step of drying. In certain embodiments, the wet food consists of a chunk form, more particularly of chunks in gravy form. In certain embodiments, the wet food consists of chunks and gravy, chunks in jelly, loaf, mousse, terrine, bites form.

“Chunks and gravy” products include a preformed meat particle prepared by making a meat emulsion and by putting this meat emulsion through a muzzle under pressure and then cooking. A product, such as cooked meat, is diced into chunks, which are eventually mixed with a gravy or sauce. The two components are then filled into a container, usually a can or pouch, which is seamed or sealed and sterilized. As opposed to the ground loaf, chunk and gravy compositions have physically separated, discrete chunks (i.e., pieces of ground meat and grains) as prepared. These discrete particles are present in the gravy-type liquid in the final container. When serving, chunk and gravy products flow out of the can and can be easily mixed with other dry products. While the chunk and gravy products allow better integrity of the individual ingredients, the heterogeneous formulation of the chunk and gravy products are sometimes disfavored by consumers.

Wet food compositions are generally packaged in can-like containers and are considered “wet” in appearance because of the moisture contained therein. Two types of wet compositions are generally known in the art. The first is known in the art as “ground loaf.” Loaf products are typically prepared by contacting a mixture of components under heat to produce an essentially homogeneous, intracellular honeycomb-type mass or “ground loaf.” The ground loaf mass is then packaged into a cylindrical container, such as a can. Upon packing, ground loaf assumes the shape of the container such that the ground loaf must be cut when serving to a companion animal.

In certain embodiments, the wet food composition can be packaged. In this way, the consumer is able to identify, from the packaging, the ingredients in the food product and confirm that it is suitable for the particular pet in question. The packaging can be metal, plastic, paper, or card.

As used herein, the term “dry food” or “dry food composition” generally refers to a food or composition having a moisture content of less than about 12% by weight, relative to the total weight of the food composition, and commonly even less than about 7% by weight, relative to the total weight of the food composition. In certain embodiments, dry food according to the present disclosure can have a moisture content of at most about 12% by weight. In certain embodiments, the said dry food can have a moisture content of about 7% or less, such as about 5% by weight. In certain embodiments, the dry food can have a moisture content of more than about 3% by weight, relative to the total weight of the food composition. For instance, the Examples provided herein illustrate a dry food having a moisture content of about 9.5% by weight, relative to the total weight of the food composition. In a certain embodiment, the dry food can be in the form of kibble. In certain embodiments, for example and without limitation, kibbles can include particulates, pellets, pieces of pet food, dehydrated meat, meat analog, vegetables, and combinations thereof. In certain embodiments, for example and without limitation, kibbles can include pet snacks, such as meat or vegetable jerky, rawhide, and biscuits.

The dry food composition can be manufactured by mixing together ingredients and kneading in order to make consistent dough that can be cooked. In general, it can be the final product of a process comprising an extrusion step followed by a drying step. The process of creating a dry pet food can usually be done by baking and/or extruding. The dough can be typically fed into a machine called an expander and/or extruder, which uses pressurized steam or hot water to cook the ingredients. While inside the extruder, the dough is under extreme pressure and high temperatures. The dough can then be pushed through a die (specifically sized and shaped hole) and then cut off using a knife. The puffed dough pieces are made into a dry product, such as a kibble, by passing it through a dryer so that moisture is dropped down to a defined target ensuring stability of the food until consumption. The product/kibble can then be sprayed with fats, oils, minerals, vitamins, natural extracts cocktail, flavors and optionally sealed into packages.

As used herein, the term “kibble” includes a particulate pellet like component of animal feeds, such as dog and cat feeds, typically having a moisture, or water, content of less than 12% by weight, relative to the total weight of the kibble. Kibbles can range in texture from hard to soft. Kibbles can range in internal structure from expanded to dense. Kibbles can be formed by an extrusion process. For instance, a kibble can be formed from a core and a coating to form a kibble that is coated, also called a coated kibble. It should be understood that when the term “kibble” is used, it can refer to an uncoated kibble or a coated kibble.

The process of creating a dry food is usually done by baking and/or extruding. The dough is typically fed into a machine called an expander and/or extruder, which uses pressurized steam or hot water to cook the ingredients. While inside the extruder, the dough is under extreme pressure and high temperatures. The dough is then pushed through a die (specifically sized and shaped hole) and then cut off using a knife. The puffed dough pieces are made into kibble by passing it through a dryer so that moisture is dropped down to a defined target ensuring stability of the food until consumption. The kibble can then be sprayed with fats, oils, minerals, vitamins, the natural extracts cocktail and optionally sealed into packages. In certain embodiments, the dry food composition is packaged. In this way, the consumer is able to identify, from the packaging, the ingredients in the food product and confirm that it is suitable for the particular pet, e.g., dog, in question. The packaging can be metal, plastic, paper or card.

In a particular embodiment, the composition is a dry food composition, in particular is in the form of a kibble.

As used herein, the term “semi-moist food” or “semi-moist food composition” generally refers to a food composition with an intermediate moisture content of about 12% to about 30% in weight, relative to the total weight of the food composition. Hence, such semi-moist food composition is generally the final product of a process allowing a moisture content value that is intermediate between a dry food and a wet food. In certain embodiments, the said process can comprise a step of adding a humectant agent. In certain embodiments, the said process can comprise an extrusion step and a subsequent treatment step with Super-Heated Stream (SHS). In certain embodiments, the semi-moist food according to the present disclosure can contain more than about 12% and at most about 30% moisture by weight, relative to the total weight of the food composition. In certain embodiments, a semi-moist food composition can have about 11% to about 20% moisture by weight, relative to the total weight of the food composition, and/or a water activity of about 0.64 to about 0.75. In certain embodiments, a semi-moist food composition can have about 11% to about 20% moisture by weight, relative to the total weight of the food composition, and a water activity of about 0.64 to about 0.75.

As used herein, “hypoallergenic food composition” refers to a composition for which a substantially limited or no allergic reaction is achieved upon consumption of the composition. Hypoallergenic food compositions disclosed herein can be dry or wet food compositions. In particular, hypoallergenic food compositions can be dry food compositions.

In the present disclosure, the expressions “hypoallergenic nutritionally complete dry food composition”, “food composition” and “composition” are alternatively used to designate the hypoallergenic nutritionally complete dry food composition of the present disclosure.

As used herein, “low fat food composition” means a composition or a diet with a significantly lower fat content than regular diets. In Europe according to COMMISSION REGULATION (EU) 2020/354 of 4 Mar. 2020 a diet with a low level of fat is a diet with Fat ≤110 g/kg complete feed with a moisture content of 12% and with a dry matter energy density of 3500 kcal/kg (according to NRC06 equation based on crude fiber), which translates into low fat means fat ≤35.7 g/Mcal (ME NRC06). In USA low fat is defined as fat <9% for products with moisture <20%, presuming a dry matter energy density of 4000 kcal/kg (according to NRC 85 equation), which would translate into low fat means fat <22.5-28 g/Mcal (ME NR85). Without being binding, it can be considered that being low fat means having fat <25 g/Mcal.

As used herein, “nutritionally complete” means that the composition of the present disclosure provides the complete and balanced nutritional requirement to a companion animal. Specifically, a nutritionally complete food composition contains all known required nutrients for the intended recipient of the food composition, in all appropriate amounts and proportions based, for example, on recommendations of recognized and competent authorities in the field of animal nutrition. The nutritionally complete food composition can contain a carrier, a diluent, or an excipient. Depending on the intended use, the carrier, diluent, or excipient can be chosen to be suitable for animal use. As used herein, “nutritional support” means that the present disclosure may be used to overcome any nutritional deficiencies of a companion animal's diet so that said companion animal may have a daily complete nutritional food intake.

As used herein, the expression “adverse food reaction” is referring to an abnormal or exaggerated response of a companion animal to the ingestion of a food composition, which negative response can cause a reduced appetite that could lead to a refusal of the diet. An adverse food reaction response can be immune-mediated which is referred to as a food allergy. The said negative response can also be a non-immune-mediated response, called a food intolerance. Illustratively, an adverse food reaction encompasses pruritus, often referred as to itching, and can result in additional dermatological signs, such as alopecia, seborrhoea or pyoderma.

As used herein, the term “allergic reaction” or “allergy” is a clinical altered immune response by an individual to a dietary allergen. Symptoms of allergic reactions can affect the cutaneous (e.g., urticaria, angioedema, pruritus), respiratory (e.g., wheezing, coughing, laryngeal edema, rhinorrhea, watery/itching eyes), gastrointestinal (e.g., vomiting, abdominal pain, diarrhea), and/or cardiovascular (if a systemic reaction occurs) systems. Allergic reaction to a food composition can provoke an adverse food reaction by the companion animal feeding this food compositions.

In some embodiments, an adverse food reaction can consist of a damage of the cutaneous, respiratory, gastrointestinal, and/or cardiovascular systems. A damage of the cutaneous system can include urticaria, angioedema, alopecia, seborrhoea, pyoderma, and/or pruritus. A damage of the respiratory system can include of wheezing, coughing, laryngeal edema, rhinorrhea, and/or watery/itching eyes. A damage of the gastrointestinal system can include vomiting, abdominal pain, and/or diarrhea. A damage of the cardiovascular system can include angina, heart attacks and/or heart failure.

As used herein, “hyperlipidemia” (also sometimes referred to as hyperlipoproteinemia), “endocrine disorder” or “lipid metabolism disorder” is a disturbance of lipid metabolism that results in an elevation in lipids in the blood, particularly triglycerides (triacylglycerides) and/or cholesterol. Among companion animals, the most clinically relevant type of hyperlipidemia is the finding of an excess concentration of triglycerides in the blood, hypertriglyceridemia (or hypertriacylglyceridemia). Primary causes of hyperlipidemia can be either genetic or familial. The principal forms in companion animals can be idiopathic hyperlipidemia of Miniature Schnauzers and hyperchylomicronemia of cats. Secondary hyperlipidemia can be associated with endocrine disorders (i.e., diabetes mellitus, hypothyroidism, and hyperadrenocorticism) or pancreatitis.

As used herein “fat intolerance” is a condition that makes companion animals unable to tolerate usual fat levels.

As used herein, “fat malassimilation” or “fat malabsorption” is a condition referring to a disturbance or disruption of the fat digestion and/or absorption by the companion animal. Dietary fat is one of the most complex nutrients to process in the gastrointestinal tract. Because this process involves multiple organs and multiple steps, disruption of fat digestion and absorption may take place in several gastroenterologic disorders. The resulting fat malassimilation not only interferes with fat absorption, but also interferes with fat-soluble vitamin, mineral, and bile salt absorption. Malabsorbed fat and bile acids are hydroxylated and deconjugated by colonic bacteria to produce potent secretagogues. The deconjugated bile acids and hydroxylated fatty acids can be toxic to the colonic mucosa, causing increased mucosal permeability, altered motility, and secretory diarrhea. Companion animals with this type of diarrhea can become rapidly dehydrated, develop electrolyte abnormalities, and experience rapid weight loss.

Animals with fat intolerance and/or fat malassimilation can show signs such as diarrhea and weight loss, or steatorrhea (excessive excretion of fat in the stool, resulting in large, pale, greasy, and malodorous stools) in more severe cases.

As used herein “lymphangiectasia” or “intestinal lymphangiectasia (IL)” is a disorder characterized by dilation, obstruction, and/or dysfunction of the lymphatic vessels within the small intestine. Dogs with IL often suffer from diarrhea, weight loss, vomiting, and fluid accumulations secondary to protein loss from the intestine. IL in dogs may occur as a primary condition or as a consequence of another condition that results in altered lymphatic flow, such as chronic inflammatory enteropathies (CIE).

### 5.2. Units

The amount of the components of the composition according to the disclosure herein are generally expressed by weight per Mcal (megacalorie), unless specifically expressed otherwise (such as, without limitation, in % as fed).

As used herein, an amount of a component as expressed as weight/Mcal consists of a weight amount of the said component by unit of Metabolizable Energy (ME) of the total animal food composition.

As used herein, the ME parameter is intended to represent the energy value of a food composition that is directly metabolized after consumption. Within the scope of the present disclosure, the ME value can be measured by any suitable method known in the art.

Illustratively, the ME value can be measured using feeding trial. In practice, the gross energy (GE) of the food is determined in the laboratory, and the amounts of food eaten by the animals are recorded. The feces and urine from the animals are collected, and the energy in each is determined and called fecal energy (FE) and urinary energy (UE), respectively. The ME is then calculated as:

$$ME ( kcal / kg ) = [ GE - ( FE + UE ) ] / Kg of food consumed .$$

Alternatively, the ME value can be measured by a mathematical method, in particular taking into account the percentage of crude fat (CF), of crude protein (CP), and NFE (carbohydrates) in the composition. In practice each percentage is multiplied by its respective Atwater Factors. The resulting sum is then multiplied by 10. The mathematical method can be represented by the following formula:

$$ME ( kcal / kg ) = 10 \times [ ( 3.5 \times CP ) + ( 8.5 \times CF ) + ( 3.5 \times NFE ) ] .$$

To calculate nutrient inclusion on an energy basis, the energy density of the diet (in kcal/kg), and the nutrient concentration in the diet, in % or mg/kg, are required. The nutrient value can be calculated with the following formulas:

$$Nutrient value in g / Mcal = ( 10 \times nutrient concentration in diet in \% as fed ) / ( energy density of diet in kcal / kg ) \times 1000$$

$$Nutrient value in mg / Mcal = ( nutrient concentration in diet in mg / kg ) / ( energy density of diet in kcal / kg ) \times 1000$$

or
   For example, a diet with 180 mg/kg of zinc, an energy density of diet that is 3900 kcal/kg, means there is 180 mg of zinc in 3900 kcal, so there is 1000 kcal (Mcal): Nutrient value of zinc=180/3900×1000=46 mg/Mcal.
   In some embodiments, the ME can be determined according to the predictive equation proposed by the National Research Council (NRC) in 2006 which is shown to be more accurate than previous ones for animal food compositions (Calvez et al., PLoS One. 2019).

In a particular embodiment of the disclosure, especially for a feline, the ME, in kcal/100 g, can be calculated as:

$$ME = GE \times [ 95.6 - ( 0.89 \times TDF \times 100 / DM ) ] / 100 ) - ( 0.77 \times CP ) or$$

$$ME = GE \times [ 87.9 - ( 0.88 \times CF \times 100 / DM ) ] / 100 ) - ( 0.77 \times CP ) with$$

$$GE = ( 5.7 \times CP ) + ( 9.4 \times CF ) + [ 4.1 \times ( NFE + CF ) ]$$

In a particular embodiment of the disclosure, especially for a canine, the ME, in kcal/100 g, can be calculated as:

$$ME = GE \times [ 96.6 - ( 0.95 \times TDF \times 100 / DM ) ] / 100 ) - ( 1.04 \times CP ) or$$

$$ME = GE \times [ 91.2 - ( 1.43 \times CF \times 100 / DM ) ] / 100 ) - ( 1.04 \times CP ) with$$

$$GE = ( 5.7 \times CP ) + ( 9.4 \times CF ) + [ 4.1 \times ( NFE + CF ) ]$$

### 5.3. Low Fat Hypoallergenic Food Compositions

The present disclosure provides low fat hypoallergenic food compositions. As it will emerge from the examples below, it is demonstrated that a low fat hypoallergenic nutritionally complete pet food composition comprising hydrolysed proteins, starch from a rice source, fibers and less than about 25 g/Mcal of fat remains of good palatability, is highly digestible, and has the ability to improve the health of companion animals that are affected with a gastrointestinal disorder.

### 5.3.1. Proteins

A food composition according to the present disclosure can contain one or more distinct source(s) of proteins. In a particular embodiment, the food composition as described herein can include a single source of proteins. In certain embodiments, the composition of the disclosure includes from about 50 g/Mcal to about 80 g/Mcal of proteins.

The protein content of the composition of the disclosure shall be high enough so as to ensure maintenance of lean body mass. In certain embodiments, a composition according of the disclosure can include proteins, hydrolysed or non-hydrolysed, in an amount ranging from about 50 g/Mcal to about 80 g/Mcal of protein. In particular embodiments, the composition of the disclosure can include from about 55 g/Mcal to about 80 g/Mcal of protein, from about 55 g/Mcal to about 75 g/Mcal of protein, from about 60 g/Mcal to about 80 g/Mcal, or from about 60 g/Mcal to about 75 g/Mcal of protein. In certain embodiments, the disclosure can include about 70 g/Mcal of protein.

As used herein, a protein content ranging from about 50 g/Mcal to about 80 g/Mcal can include a protein content of 50 g/Mcal, 51 g/Mcal, 52 g/Mcal, 53 g/Mcal, 54 g/Mcal, 55 g/Mcal, 56 g/Mcal, 57 g/Mcal, 58 g/Mcal, 59 g/Mcal, 60 g/Mcal, 61 g/Mcal, 62 g/Mcal, 63 g/Mcal, 64 g/Mcal, 65 g/Mcal, 66 g/Mcal, 67 g/Mcal, 68 g/Mcal, 69 g/Mcal, 70 g/Mcal, 71 g/Mcal, 72 g/Mcal, 73 g/Mcal, 74 g/Mcal, 75 g/Mcal, 76 g/Mcal, 77 g/Mcal, 78 g/Mcal, 79 g/Mcal and 80 g/Mcal.

Proteins which are suitable for the compositions of the disclosure can be from a vegetal or animal source. Any suitable animal source of proteins can be used including, without limitation, poultry, chicken, chicken meal, lamb, lamb meal, fish, fish meal, meat and bone meal, meat byproducts, meat meal, turkey, blood plasma, insects, bone marrow and feather. Any suitable vegetal source of proteins can be used including, without limitation, soya, chickpea, corn, rice, lentils, or barley.

In certain embodiments, a composition of the disclosure does not include non-hydrolysed proteins. In particular embodiments, the composition of the disclosure does not include non-hydrolysed proteins from wheat gluten, dried egg, beef, chicken, yeast, potato protein, and pea protein.

In certain embodiments, the composition of the disclosure includes from about 50 to about 80 g/Mcal of proteins, said proteins including at least about 80% of hydrolysed proteins meaning the protein content of the composition according to the disclosure can include at least about 80%, at least about 85%, at least about 90%, at least about 95%, at least about 98%, at least about 99%, or at least about 100% of hydrolysed proteins by weight of the total amount of proteins in the composition. As used herein, proteins containing at least 80% of hydrolysed proteins can include proteins containing about 80%, 81%, 82%, 83%, 84%, 85%, 86%, 87%, 88%, 89%, 90%, 91%, 92%, 93%, 94%, 95%, 96%, 97%, 98%, 99% or 100% of hydrolysed proteins, by weight of the total amount in the composition.

In certain embodiments, hydrolysed vegetal proteins can be used, such as in particular soja. In particular embodiments, hydrolysed proteins from feather, particularly from poultry feather, can be used. In a particular embodiment, the single source of protein is a feather hydrolysate, in particular a poultry feather hydrolysate.

In particular embodiments, hydrolysed proteins are the only source of proteins in a composition of the disclosure. In certain embodiments, a composition of the disclosure can include as the only source of proteins, hydrolysed vegetal proteins. In particular embodiments, the hydrolysed proteins are from a single source of proteins. In certain embodiments, said single source of proteins may be selected from a vegetal source of proteins, in particular a vegetal source of proteins selected from soya, chickpea, corn, rice, lentils, or barley. In certain embodiments, said single source of proteins may be feather hydrolysates, in particular poultry feather hydrolysates.

Methods to hydrolyse proteins are well-known. A hydrolysate can be produced by any known chemical or enzymatic method, such as, in a non-limiting example, methods disclosed in U.S. Pat. Nos. 5,589,357, 4,879,131, 5,039,532 or EP 1 236 405 B1, incorporated herein by reference.

In certain embodiments, the hydrolysed proteins can have a molecular weight ranging from about 1,000 Da to about 15,000 Da, from about 1,000 Da to about 11,000 Da, from about 1,000 Da to about 5,000 Da, from about 2,000 Da to about 15,000 Da, from about 2,000 Da to about 11,000 Da, or from about 2,000 Da to about 5,000 Da.

As used herein, ranging from about 1,000 Da to about 15,000 Da includes 1,000 Da, 1,250 Da, 1,500 Da, 1,750 Da, 2,000 Da, 2,250 Da, 2,500 Da, 2,750 Da, 3,000 Da, 3,250 Da, 3,500 Da, 3,750 Da, 4,000 Da, 4,250 Da, 4,500 Da, 4,750 Da, 5,000 Da, 5,250 Da, 5,500 Da, 5,750 Da, 6,000 Da, 6,250 Da, 6,500 Da, 6,750 Da, 7,000 Da, 7,250 Da, 7,500 Da, 7,750 Da, 8,000 Da, 8,250 Da, 8,500 Da, 8,750 Da, 9,000 Da, 9,250 Da, 9,500 Da, 9,750 Da, 10,000 Da, 10,250 Da, 10,500 Da, 10,750 DA, 11,000 Da, 11,250 Da, 11,500 Da, 11,750 Da, 12,000 Da, 12,250 Da, 12,500 Da, 12,750 Da, 13,000 Da, 13,250 Da, 13,500 Da, 13,750 Da, 14,000 Da, 14,250 Da, 14,500 Da, 14,750 Da and 15,000 Da.

### 5.3.2. Fibers

A food composition according to the present disclosure can contain one or more distinct source(s) of fibers and type of fibers. Generally, a food composition as described herein includes a plurality of sources of fibers.

The total dietary fibers (TDF) are the remnants of edible plant cell wall polysaccharides, lignin, and associated substances resistant to hydrolysis by alimentary tract enzymes. As used herein, the dietary fiber represents the indigestible part of plant foods. The most common dietary fibers are lignin, cellulose, hemicellulose, pectin and gums. Dietary fibers suitable for a composition of the present disclosure can include lignin, cellulose, hemicellulose, pectin, gums, beta-glucans or a combination thereof.

In certain embodiments, the food composition includes from about 10 g/Mcal to about 30 g/Mcal, from about 10 g/Mcal to about 20 g/Mcal, from about 20 g/Mcal to about 30 g/Mcal, or from about 15 g/Mcal to about 25 g/Mcal, from about 15 g/Mcal to about 20 g/Mcal, or about 16 g/Mcal of total dietary fibers (TDF).

As used herein, from about 10 g/Mcal to about 30 g/Mcal can include 10 g/Mcal, 11 g/Mcal, 12 g/Mcal, 13 g/Mcal, 14 g/Mcal, 15 g/Mcal, 16 g/Mcal, 17 g/Mcal, 18 g/Mcal, 19 g/Mcal, 20 g/Mcal, 21 g/Mcal, 22 g/Mcal, 23 g/Mcal, 24 g/Mcal, 25 g/Mcal, 26 g/Mcal, 27 g/Mcal, 28 g/Mcal, 29 g/Mcal and 30 g/Mcal.

Illustratively, a source of dietary fiber suitable for implementing a composition according to the instant disclosure includes rice hulls, corn and corn by-products, soybean hulls, beet pulp, dried potato product, cellulose, bran, peanut hulls, pectin and a mixture thereof.

As used herein total dietary fibers can include soluble fibers and insoluble fibers. Without being binding it is commonly accepted that soluble fibers can be defined as being resistant to digestion and absorption in the small intestine and undergo complete or partial fermentation in the large intestine. Without being binding, it is commonly accepted that insoluble fibers can be defined as non-starch polysaccharides that are resistant to digestion and absorption in the small intestine, and resistant to fermentation in the large intestine.

In certain embodiments, a suitable source of soluble fibers, for the purpose of the instant disclosure, can be selected from beet pulp, guar gum, chicory pulp, chicory root, psyllium, pectin, blueberry, cranberry, squash, apples, oats, beans, citrus, barley, and peas.

In particular embodiments, a suitable source of insoluble fibers, for the purpose of the instant disclosure, can be selected from cellulose, whole wheat products, wheat oat, corn bran, flax seed, grapes, celery, green beans, cauliflower, potato skins, fruit skins, vegetable skins, peanut hulls, and soy fiber.

### 5.3.3. Carbohydrates or NFE

As used herein, and as conventionally admitted in the art, the Nitrogen Free Extract (NFE) consists of the soluble carbohydrate fraction that is present in a food composition disclosed herein. NFE encompasses soluble polysaccharides, starch, gums, mucilages and pectin, if present in the said food composition.

Thus, as it is conventionally admitted in the art, NFE does not include the insoluble carbohydrate fraction within the crude fiber material that may, in certain embodiments, be present in the said food composition.

Typically, the content of a food composition in Nitrogen Free Extract can be determined by subtracting the content of each of the other components (protein, fat, crude fiber, ash) from the whole dry matter of the said food composition.

NFE, or carbohydrates, may be supplied under any suitable source(s), as known in the art. A suitable source of NFE may be selected from oat fiber, cellulose, peanut hulls, beet pulp, parboiled rice, corn starch, corn gluten meal, and any combination of those sources. Grains supplying carbohydrate include, but are not limited to, wheat, corn, barley, and rice.

In particular embodiments, the composition according to the instant disclosure can include from about 130 g/Mcal to about 190 g/Mcal, from about 130 g/Mcal to about 160 g/Mcal, from about 130 g/Mcal to about 150 g/Mcal, from about 140 g/Mcal to about 190 g/Mcal, from about 140 g/Mcal to about 160 g/Mcal of NFE, from about 140 g/Mcal to about 150 g/Mcal of NFE, or about 145 g/Mcal of NFE.

As used herein, a NFE content ranging from about 130 g/Mcal to about 190 g/Mcal can include a protein content of 130 g/Mcal, 131 g/Mcal, 132 g/Mcal, 133 g/Mcal, 134 g/Mcal, 135 g/Mcal, 136 g/Mcal, 137 g/Mcal, 138 g/Mcal, 139 g/Mcal, 140 g/Mcal, 141 g/Mcal, 142 g/Mcal, 143 g/Mcal, 144 g/Mcal, 145 g/Mcal, 146 g/Mcal, 147 g/Mcal, 148 g/Mcal, 149 g/Mcal, 150 g/Mcal, 151 g/Mcal, 152 g/Mcal, 153 g/Mcal, 154 g/Mcal, 155 g/Mcal, 156/Mcal, 157 g/Mcal, 158 g/Mcal, 159 g/Mcal, 160 g/Mcal, 161 g/Mcal, 162 g/Mcal, 163 g/Mcal, 164 g/Mcal, 165 gg/Mcal, 166 g/Mcal, 167 g/Mcal, 168 g/Mcal, 169 g/Mcal, 170 g/Mcal, 171 g/Mcal, 172 g/Mcal, 173 g/Mcal, 174 g/Mcal, 175 g/Mcal, 176 g/Mcal, 177 g/Mcal, 178 g/Mcal, 179 g/Mcal, 180 g/Mcal, 181 g/Mcal, 182 g/Mcal, 183 g/Mcal, 184 g/Mcal, 185 g/Mcal, 186 g/Mcal, 187 g/Mcal, 188 g/Mcal, 189 g/Mcal and 190 g/Mcal.

### 5.3.4. Starch

Digestible carbohydrates provide an important source of energy for the body in the form of glucose, which is the main form of energy for tissues like the brain and red blood cells. Digestible carbohydrates include complex carbohydrates like starches (polysaccharides) and sugars (monosaccharides and disaccharides). When carbohydrate supply is limited, glucose can also be synthesized from proteins and other compounds. An adequate amount of starch in a diet allows to spare the use of protein.

For the composition of the disclosure, fat needs to be restricted but it was necessary to have an energy density as high as possible, which is one of the reasons why a high level of starch is targeted. Increasing the level of starch has been preferentially used for this purpose contrary to other alternatives considering the metabolizable energy level of carbohydrates such as starch compared to protein for example. From a nutrition standpoint, dietary carbohydrates such as starch can provide a highly digestible energy source and spares protein. This means that when a body uses carbohydrate to provide needed energy, dietary protein is conserved from being used for this purpose and continues to be available for use to provide essential amino acids, build and repair body tissues, support a healthy immune system. In addition, increasing the amount of proteins could have negatively impacted the palatability (as hydrolysed proteins are known to be unpalatable).

The composition of the disclosure includes from about 120 g/Mcal to about 180 g/Mcal of starch, from about 120 g/Mcal to about 160 g/Mcal, from about 140 g/Mcal to about 180 g/Mcal, from about 140 g/Mcal to about 160 g/Mcal, or from about 130 to about 150 g/Mcal. In certain embodiments, the starch is from at least one rice source.

In particular embodiments, the food composition as described includes one source of starch. In certain embodiments, the said one source of starch is rice. In particular embodiments, the one source of starch is one rice source.

In certain embodiments, the one source of starch is a combination of several rice sources. In particular embodiments, the source of starch can be any type of rice. In certain embodiments, the rice is not a complete rice.

In certain embodiments, the rice source can include rice, broken rice grain, rice flour, whole grain rice, or a combination thereof. In particular embodiments, the rice source can include broken rice grain, rice flour, or a combination thereof.

As defined herein, broken rice grain is intended to mean grains of rice that would have been considered as non-compliant for human food, for whatever the reason (appearance, color, integrity, etc.). Broken rice grains can have an average particle size of about 2 mm to about 5 mm.

As defined herein, rice flour is intended to mean thin flour which can be obtained by mechanical grinding and sieving of broken rice. Rice flour can have an average particle size of about 150 μm.

According to an embodiment of the disclosure, the rice source can include at least about 30%, at least about 40%, at least about 50%, or at least about 60% of rice flour, by weight of the total amount of rice source in the composition.

As used herein, the source of rice can include about 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 85%, 83%, 84%, 85%, 86%, 87%, 88%, 89%, 90%, 91%, 92%, 93%, 94%, 95%, 96%, 97%, 98%, 99% or 100% of rice flour, by weight of the total amount of rice source in the composition.

According to some embodiments, a composition of the disclosure does not include any starch from a source other than rice, and more particularly from tapioca, corn, barley or wheat.

### 5.3.5. Fat

As used herein, the expressions “fat”, “crude fat”, or “source of fat” are intended to refer to any food-acceptable fat and/or oil. The fat in accordance with the present disclosure can be indifferently in a fluid form and/or in a solid form. The composition according to the disclosure can include fat from animal origin and/or from vegetal origin. Fat can be supplied by any suitable source known by those skilled in the art. The fat content of food compositions according to the instant disclosure can be determined by any method known in the art.

In particular embodiments, the composition according to the disclosure includes less than about 25 g/Mcal of fat, less than about 24 g/Mcal, less than about 22 g/Mcal, or less than about 20 g/Mcal of fat. In certain embodiments, the composition according to the disclosure can include from about 10 to about 24 g/Mcal of fat, from about 15 to about 22 g/Mcal of fat, or from about 18 to about 20 g/Mcal of fat.

As used herein, less than about 25 g/Mcal of fat can include a fat content of about 25 g/Mcal, 24 g/Mcal, 23 g/Mcal, 22 g/Mcal, 21 g/Mcal, 20 g/Mcal, 19 g/Mcal, 18 g/Mcal, 17 g/Mcal, 16 g/Mcal, 15 g/Mcal, 14 g/Mcal, 13 g/Mcal, 12 g/Mcal, 11 g/Mcal or about 10 g/Mcal.

In a particular embodiment, the source of fat is selected from vegetal fat, animal fat, or mixtures thereof. A suitable vegetal source of fat for the purpose of the instant disclosure can include, without limitation, wheat fat, soya oil, sunflower, safflower, rapeseed, olive, borage, flaxseed, peanuts, blackcurrant seed, cottonseed, germ, corn germ as well as oils derived from these and any combination thereof. A suitable animal source of fat for the purpose of the instant disclosure can include, for example and without limitation, meat, meat by-products such as chicken fat, turkey fat, beef fat, duck fat, pork fat, lamb fat, fish oil, krill oil, seafood, dairy, eggs and combinations thereof.

Illustratively, the fat content can include a source of linoleic acid, alpha-linoleic acid, arachidonic acid, omega-6 fatty acids, omega-3 fatty acids, eicosapentaenoic acid (EPA), docosahexaenoic acid (DHA) and a mixture thereof (EPA+DHA).

In particular embodiments, the composition according to the disclosure can include from about 0.2 g/Mcal to about 1 g/Mcal of EPA+DHA, from about 0.3 g/Mcal to about 0.8 g/Mcal EPA+DHA, from about 0.4 g/Mcal to about 0.6 g/Mcal of EPA+DHA, or about 0.4 g/Mcal of EPA+DHA.

In an embodiment, the composition according to the disclosure can include from about 3 g/Mcal to about 8 g/Mcal of Linoleic Acid (LA), particularly from about 4 g/Mcal to about 6 g/Mcal of LA and more particularly about 4.5 g/Mcal.

### 5.3.6. Ash

In some embodiments, a composition according to the instant disclosure can include from about 5 g/Mcal to about 8 g/Mcal of ash, from about 6 g/Mcal to 7 g/Mcal of ash, or about 6.2 g/Mcal of ash.

Within the scope of the instant disclosure, the ash is intended to refer to minerals, such as calcium, phosphorus, sodium, chloride, potassium and magnesium.

### 5.3.7. Other Ingredients

A composition according to the instant disclosure can further include one or more trace element(s), in particular a trace element selected from iron, copper, manganese, zinc, iodine and selenium. The composition according to the instant disclosure can further include one or more vitamin(s), in particular a vitamin selected from vitamin A, vitamin D, vitamin E, ascorbic acid, vitamin K, thiamine, riboflavin, pantothenic acid, niacin, pyridoxine, folic acid, biotin, vitamin B12 and choline.

In certain embodiments, the food composition according to the present disclosure can further include a source of antioxidants. As used herein, the expression “antioxidant” is intended to refer to a substance that is capable of reacting with free radicals and neutralizing them. Illustrative examples of such substances include, without limitation, carotenoids, including beta-carotene, lycopene and lutein, selenium, coenzyme Q10 (ubiquinone), tocotrienols, soy isoflavones, S-adenosylmethionine, glutathione, taurine, N-acetylcysteine, vitamin E, vitamin C, lipoic acid and L-carnitine.

In certain embodiments, the composition can further include at least one flavour, in particular a natural flavour. In particular embodiments, the flavour can be of protein origin.

According to a particular embodiment, a composition of the present disclosure can further include one or more additional ingredients selected from colorants, flavors, fillers, conservatives such as antioxidants including lutein or beta carotene, vitamins such as choline, amino acids such as taurine, trace elements such as zinc, and minerals.

### 5.4. Uses and Methods of Making Low Fat Hypoallergenic Food Compositions

The present disclosure also relates to a method of manufacturing a low fat hypoallergenic nutritionally complete food composition for a companion animal as defined above including at least a step of mixing all the ingredients together.

Considering the low-fat content of the composition and the role of fat in dog's palatability, the maximum of available fat should be applied on the product externally to remain palatable. On the other hand, low fat application at coating needs to be well managed to deliver a good homogeneity and ensure the right palatability performance.

The disclosure further relates to a low fat hypoallergenic nutritionally complete food composition according to the disclosure or obtained with the method according to the disclosure for use in nutritional support of a companion animal suffering from adverse food reaction. The disclosure also relates to a low fat hypoallergenic nutritionally complete food composition according to the disclosure or obtained with the method of the disclosure for use in nutritional support of a companion animal suffering from fat intolerance and/or fat malassimilation.

The disclosure further relates to a low fat hypoallergenic nutritionally complete food composition obtained with the method of the disclosure for use in nutritional support of a companion animal suffering from hyperlipidemia.

The disclosure further refers to a method for reducing the clinical signs of fat intolerance and/or fat malassimilation in a companion animal, said method including at least a step of providing to the companion animal a low fat hypoallergenic nutritionally complete food composition according to the disclosure or obtained with the method of the disclosure.

The disclosure further refers to a method for reducing the likelihood of occurrence of fat intolerance and/or fat malassimilation in a companion animal, said method including at least a step of providing to the companion animal a low fat hypoallergenic nutritionally complete food composition according to the disclosure or obtained with the method of the disclosure.

It also relates to a method for reducing the clinical signs of hyperlipidemia in a companion animal, said method including at least a step of providing to the companion animal a low fat hypoallergenic nutritionally complete food composition according to the disclosure or obtained with the method of the disclosure.

It also relates to a method for reducing the likelihood of occurrence of hyperlipidemia in a companion animal, said method including at least a step of providing to the companion animal a low fat hypoallergenic nutritionally complete food composition according to the disclosure or obtained with the method of the disclosure.

It also relates to a method for reducing the clinical signs of adverse food reaction in a companion animal, said method including at least a step of providing to the companion animal a low fat hypoallergenic nutritionally complete food composition according to the disclosure or obtained with the method of the disclosure.

Finally, the disclosure relates to a method for reducing the likelihood of occurrence of adverse food reaction in a companion animal, said method including at least a step of providing to the companion animal a low fat hypoallergenic nutritionally complete food composition according to the disclosure or obtained with the method of the disclosure.

The disclosure also relates to a low fat hypoallergenic nutritionally complete food composition according to the disclosure or obtained with the method of the disclosure for use in the prevention or the treatment of fat intolerance and/or fat malassimilation in a companion animal.

The present disclosure further relates to a low fat hypoallergenic nutritionally complete food composition according to the disclosure or obtained with the method of the disclosure for use in the prevention or the treatment of hyperlipidemia in a companion animal.

The disclosure finally relates to a low fat hypoallergenic nutritionally complete food composition according to the disclosure or obtained with the method of the disclosure for use in the prevention or the treatment of adverse food reaction in a companion animal.

As used herein, the terms “treating” or “treat” include alleviation of the symptoms associated with a specific disorder or condition and/or elimination of said symptoms. In the context of the present disclosure, the term “prevent” denotes the reduction to a lesser degree of the risk or of the probability of occurrence of a given phenomenon, for example in the present disclosure: fat intolerance and/or fat malassimilation, hyperlipidemia and/or adverse food reaction.

### 6. EXAMPLES

### Example 1: Manufacturing a Dry Food Composition of the Disclosure

A dry food composition according to the disclosure was prepared according to the method described here below.

The composition, as a non-limitative example, had the following formula (g/Mcal and % as fed) in Table 1:

TABLE 1

| Ingredients | g/Mcal** | % as fed |
|---|---|---|
| Protein (of which is | About 71 | About 25 |
| hydrolysed protein) | | |
| Fat: | About 20 | About 7 |
| Linoleic acid | About 4.5 | About 1.57 |
| EPA + DHA | About 0.5 | About 0.15 |
| Omega3 fatty acids | About 0.3 | About 0.3 |
| Starch (from rice*) | About 132.5 | About 46.5 |
| TDF (Total Dietary Fibers) | About 16.5 | About 5.8 |
| Ash | About 17.5 | About 6.2 |
| Other classic ingredients | About 27 | About 9.5 |
| (preservatives, vitamins, | | |
| minerals, trace elements, | | |
| amino acids, flavours, | | |
| colouring, etc.) | | |
| TOTAL | — | About 100 |

*including at least about 30% of rice flour.
**considering an energy density of diet of about 3500 kcal/kg

The ingredients were mixed in the proportions indicated in the table above, first the dry ingredients, then the wet ingredients.

The composition was prepared using a classic extrusion process:
1. Dosing: mixing the dry ingredients to obtain a meal and giving the line throughput
2. Preconditioning: hydration and precooking of the meal with water and steam injection. Addition of the remaining liquids. The average retention time was about 3 mn. At the exit of the preconditioner, the meal was hydrated and pre-heated (temperature around 85-90° C.) but still under powder form, without showing any clumps, meal balls or sticking.
3. Extrusion: final step of cooking and forming (cutting). Adding the remaining quantity of steam/water needed. Final cooking with mechanical energy.

The final process parameters were set to limit the stickiness in the preconditioner and avoid blockage in the downspout between preconditioner and extruder. Water and steam were adjusted in the preconditioner to have a good hydration homogeneity but a lower meal temperature.

The final cooking was made mainly in the extruder by the disruption brought by the screw and the plate opening area. As a result, a higher Specific Mechanical Energy (SME at 50-55) was obtained for this formula compared to what used to be obtained.

### Example 2: Palatability Study-Comparison Between a Food Composition of the Disclosure and a Commercially Available Hypoallergenic Pet Food Composition

The palatability of the composition of the disclosure was determined using a “Two Bowl Test”. This test allows to determine the palatability of a food regarding the food preference of the animal between two different food products.

A panel of 33 dogs were fed a food composition of the disclosure, prepared as described in Example 1 (Product A), and a commercially available food composition: Purina Proplan Canine Hypoallergenic® (Product B). All the 33 dogs have eaten the food normally.

Product A and Product B were placed in their respective bowls and presented simultaneously to each animal. The bowls are left with the animal for 20 minutes. The amount of food product offered in each bowl is sufficient for the animals' daily caloric intake. The test is performed twice a day. Fresh water was always available. The remaining food product were collected and weighed to determine how much of each food product was consumed by the animal. Each food product is classified alongside the others as a function of its consumption.

The palatability was measured according to the diet preference: the percentage of animals who prefer Product A, versus the percentage of animals who prefer Product B, and the percentage of animals who don't have any preference (no choice).

### Results

The results of the two-bowl test assessing palatability are presented on Table 2 below.

TABLE 2

| | |
|---|---|
| Number of dogs | 33 |
| Preference | A: 91%/B: 11%/No choice: 5% |
| Preference | P < 0.001 (VHS) |
| probability | |

In conclusion, a food composition of the disclosure was accepted by the dogs of the panel. In fact, the food composition of the disclosure was significantly more preferred than the other commercially available hypoallergenic dog food composition.

In particular, it has been shown that, contrary to the common knowledge of the person skilled in the art, the composition of the disclosure is still palatable and appealing to dogs despite not only its low amount of fat but also the high amount of hydrolysed proteins (which hydrolysed proteins are well known for not being attractive for dogs).

### Example 3: Digestibility Study of a Food Composition of the Disclosure

The aim of this study was to analyse the digestibility of a food composition of the disclosure, through the analysis of dogs' stools after being fed a diet containing such a food composition.

A panel of 9 dogs was included in this study. They were exclusively fed a food composition as prepared in Example 1 in an amount for each dog calculated according to their weight and body score condition in order to cover the energy needs of each animal.

All animals included in the study were stool graded daily during the fecal collection phase thanks to the fecal score scale.

According to the consistency of their faeces, the faeces were separated into 5 categories: very soft, soft, optimal, very hard and hard.

The results are provided in the table 3 below (the percentage corresponds to the number of dogs present in each category, compared to the total number of dogs) in Table 3:

TABLE 3

| Qualifier | Significance |
|---|---|
| very soft | 4% |
| soft | 48% |
| Optimal | 40% |
| hard | 8% |
| very hard | 0% |

In conclusion, it has been shown that the food composition of the disclosure is well tolerated by the dogs to who it was administered in terms of its digestibility.

### Example 4: Clinical Study-Administration of a Food Composition of the Disclosure to Dogs Suffering from a Gastrointestinal Disorder

The main aim of this study was to evaluate the efficacy as well as the vet and pet owner perception of a food composition of the disclosure.

### Protocol

A panel of 17 dogs were included, of which 15 completed the study.

The selection criteria were as follows:
Dogs coming to the vet clinic due to a gastrointestinal disorder (diarrhea±vomiting).
Age: from 1-12 years old
Correctly vaccinated, dewormed and treated against external parasites (fleas, ticks, etc.).
No current medication.
Chronic enteropathies: Adult animal with at least twice a week since at least 2 weeks soft or liquid stools and at least 1 or more of following signs: —increased frequency of stools —increased feces volume —vomiting With an adapted CCEAI (without albumin)>=5 for dogs, OR Recurrent enteropathies: Adult animal with soft stools OR liquids with one or several of additional following signs: increased frequency of stools, increased feces volume, vomiting AND that already consulted for soft or liquid stools at least once within the past year (except if the GI disorders caused by the consumption of inappropriate elements by the pet, stress or concomitant diseased known). With an adapted CCEAI (without albumin)>=5 for dogs.
Animals previously medicated under one or more protocols (anti-inflammatory, antibiotic) and did not fully respond to treatment were authorized.

Exclusion or Withdrawal criteria were as follows:
Severe concurrent disease.
Eating refusal, insufficient food consumption (<80% MER over 3 days) or necessity to be tube-fed.
Worsening of symptoms during trial.
Use of prohibited drugs
Removal criteria: —undesired weight loss in excess of 15% over the first months.

### Treatments

Dietary treatment only (=test diet only, no additional drug) during the trial.

### Prohibited Drugs:

Short-term and long-acting (injectable or oral) steroids,
Essential fatty acid supplements, prebiotics and probiotics.
Antibiotics treatments.

### Authorized During the Study, if Deemed Necessary by the Vet:

Treatment with no impact on GI tract: shampoos, ear cleansers, ear drops, etc.
Supportive treatment such as antiemetic, fluids, etc.
Worming medication

The dogs were fed a diet of the food composition of the disclosure exclusively during the protocol in an amount for each dog calculated according to their weight and body score condition in order to cover the energy needs of each animal. The general health status of the dogs was assessed by the veterinarian and by the pet owners at least at the following times:

Inclusion visit (V0), at DO: full clinical examination by the vet investigator, and completion of GI questionnaires.

Follow-up vet visit at 1 month (V1): follow-up/collection of owner inputs on food consumption and vet clinical examination for symptoms evolution.

Final visit (V2) at +2 months, a: same as V0+collection of owner inputs+evaluation of product efficacy.

In addition, the efficacy of the food composition diet was assessed by the veterinarian and by the pet owners during the Follow-up vet visit (V1) and the Final visit (V2).

Criteria assessed by the veterinarian (at V0, V1 and V2):
Physical examination including dog′ body weight and BCS (Body condition score) as well as hydration status (adequate if dehydration <5%/marginal if dehydration 5-8%/inadequate if dehydration >8%).
GI (gastrointestinal) Discomfort signs evaluation: presence or absence of diarrhea, vomiting, melena or hematochezia, fecal mucus, abdominal pain, tenesmus, abnormal behavior, or any other GI-related clinical sign.
GI Disorders Evaluation Scale (adapted from validated scores such as canine inflammatory bowel disease activity index (CIBDAI)

### Criteria Assessed by the Pet Owners (at V0, Day 7, V1 and V2):

Scoring of digestive signs: appetite, vomiting/nausea, stool consistency, stool frequency, pain/discomfort.
Scoring of quality of life (QoL) signs: Mobility/activity, playing/hunting, interactions with other pets/family members, grooming, happiness.

For each item they had to score from 0=normal to 3=severely modified, allowing to establish a GI score and a QoL score.

### Results

### Results of the Vet Assessment

The veterinarians assessed the clinical index activity score of each dog at V0, V1 and V2 using the CCECAI index.

The results showed that after 2 months treatment with a diet composition of the disclosure, 83% of the dogs had reduced their clinical index activity score by at least one point.

### Results of the Pet Owners Assessments

Improvement or resolution of gastrointestinal disorder signs were reported for all dogs that completed the 2 months trial.

Globally owners did not seem to notice an impact of the chronic enteropathies on the quality of life of their pets. But overall, after two months, a slight decrease of the dogs anxiety was reported. Further, over 80% of the pet owners reported an improved quality of life after 1 month.

What is claimed is:

1. A low fat hypoallergenic nutritionally complete food composition for a companion animal comprising:
a) from about 50 g/Mcal to about 80 g/Mcal of proteins, said proteins comprising at least about 80% of hydrolysed proteins,
b) from about 120 g/Mcal to about 180 g/Mcal of starch, said starch being from at least one rice source,
c) from about 10 g/Mcal to about 30 g/Mcal of Total Dietary Fibers (TDF), and
d) less than about 25 g/Mcal of fat.

2. The low fat hypoallergenic nutritionally complete food composition of claim 1, wherein said at least one rice source comprises rice, broken rice grain, rice flour, whole rice grain, or a combination thereof.

3. The low fat hypoallergenic nutritionally complete food composition of claim 1, wherein said at least one rice source comprises at least about 30% of rice flour.

4. The low fat hypoallergenic nutritionally complete food composition of claim 1, wherein the proteins comprise at least about 95% of hydrolysed proteins.

5. The low fat hypoallergenic nutritionally complete food composition of claim 1, wherein the hydrolysed proteins have a molecular weight ranging from about 1,000 Da to about 15,000 Da, in particular ranging from about 1,000 Da to about 11,000 Da, and particularly from about 2,000 Da to about 5,000 Da.

6. The low fat hypoallergenic nutritionally complete food composition of claim 1, wherein the hydrolysed proteins are from a single source of proteins.

7. The low fat hypoallergenic nutritionally complete food composition of claim 6, wherein said single source of protein is selected from a vegetal source of proteins, in particular a vegetal source of proteins selected from soya, chickpea, corn, rice, lentils, or barley.

8. The low fat hypoallergenic nutritionally complete food composition of claim 6, wherein said single source of protein is feather hydrolysates, in particular poultry feather hydrolysates.

9. The low fat hypoallergenic nutritionally complete food composition of claim 1, wherein the source of fat is selected from vegetal fat, animal fat, or mixtures thereof.

10. The low fat hypoallergenic nutritionally complete food composition of claim 9, wherein the vegetal source of fat is selected from wheat fat, soya oil, sunflower, safflower, rapeseed, olive, borage, flaxseed, peanuts, blackcurrant seed, cottonseed, germ, corn germ as well as oils derived from these and any combination thereof.

11. The low fat hypoallergenic nutritionally complete food composition of claim 9, wherein the animal source of fat comprises meat, meat by-products such as chicken fat, turkey fat, beef fat, duck fat, pork fat, lamb fat, fish oil, krill oil, seafood, dairy, eggs or combinations thereof.

12. The low fat hypoallergenic nutritionally complete food composition of claim 1, wherein said dietary fibers (TDF) comprise lignin, cellulose, hemicellulose, pectin, gums, beta-glucans or a combination thereof.

13. The low fat hypoallergenic nutritionally complete food composition of claim 1, wherein the composition further comprises one or more additional ingredients selected from colorants, flavors, fillers, conservatives such as antioxidants including lutein or beta carotene, vitamins such as choline, amino acids such as taurine, trace elements such as zinc, and minerals

14. The low fat hypoallergenic nutritionally complete food composition of claim 1, wherein the composition is a dry food composition, in particular is in the form of a kibble.

15. A method of manufacturing a low fat hypoallergenic nutritionally complete food composition for a companion animal, wherein the low fat hypoallergenic nutritionally complete food composition comprises:
a) from about 50 g/Mcal to about 80 g/Mcal of proteins, said proteins comprising at least about 80% of hydrolysed proteins,
b) from about 120 g/Mcal to about 180 g/Mcal of starch, said starch being from at least one rice source,
c) from about 10 g/Mcal to about 30 g/Mcal of Total Dietary Fibers (TDF), and
d) less than about 25 g/Mcal of fat;
wherein the method of manufacturing comprises at least one step of mixing all the ingredients together.

16. The low fat hypoallergenic nutritionally complete food composition of claim 1, wherein the low fat hypoallergenic nutritionally complete food is for a companion animal suffering from adverse food reaction.

17. A low fat hypoallergenic nutritionally complete food composition of claim 1, wherein the low fat hypoallergenic nutritionally complete food composition is for nutritional support of a companion animal suffering from fat intolerance and/or fat malassimilation.

18. The low fat hypoallergenic nutritionally complete food composition of claim 1, wherein the low fat hypoallergenic nutritionally complete food is for nutritional support of a companion animal suffering from hyperlipidemia.
